(19) United States
(12) Patent Application Publication
(10) Pub. No.: US 2004/0069141 A1
(43) Pub. Date: Apr. 15, 2004

(54) Wear protection layer for piston rings, containing wolfram carbide and chromium carbide

(76) Inventor: Christian Herbst-Dederichs, Burscheid (DE)

Correspondence Address: Howard & Howard, The Pinehurst Office Center, Suite 101, 39400 Woodward Avenue, Bloomfield Hills, MI, 48304-5151, US

(21) Appl. No.: 10/450,220

(22) PCT Filed: Nov. 17, 2001
(86) PCT No.: PCT/DE01/04336

(30) Foreign Application Priority Data
Dec. 12, 2000 (DE) 100750.6

(51) Int. Cl. F16J 1/04

(52) U.S. Cl. 92/223

(57) ABSTRACT

Protective layer for piston rings in internal combustion machines, essentially consisting of chromium carbides, tungsten carbide, chromium and nickel, whereby the protective layer against wear and tear is formed of a powder mixture in which the first powder exists as agglomerated and sintered powder made out of at least the alloy components chromium carbide, chromium and nickel, which has not experienced any subsequent embrittling heat treatment such as e.g. a plasma age hardening, whereby the carbides in the powder have a mean diameter that is essentially not greater than 3 μm and a second powder that is also present as an agglomerated and sintered powder and contains tungsten carbide as an essential characteristic and is applied to at least one area of the piston rings by means of thermal spraying, so that two differing layer areas are produced in the protective layer against wear and tear, whereby a first area develops that is primarily rich in chromium carbide and a second area develops that is chiefly rich in tungsten carbide.

### DESCRIPTION

The present invention relates to a protective layer for piston rings in internal combustion machines, essentially consisting of chromium carbides, tungsten carbide, chromium and nickel.

The contact surfaces of piston rings in internal combustion engines are subject to wear and tear during their use. To minimize the wear and tear the bearing surfaces of piston rings are supplied with a protective layer. Depending on the production method utilized, it is part of background art to produce these layers by means of a high-speed flame spraying method. In this procedure the coating material, which is present as powder, is fused by means of an oxygen/fuel spray gun and sprayed onto the piston ring. EP 0 960 954 A2 discloses a corresponding powder for generation of these protective layers against wear and tear. This powder contains nickel, chromium and carbon, whereby the chromium can be present as chromium-carbide and nickel-chromium alloy. The essay “The Application of Cermet Coating on Piston Ring by HVOF” by H. Fukutome from 1995, of the Japanese piston ring manufacturer Teikoku Piston Ring, also describes the use of chromium carbides and nickel-chromium alloys for generating protective layers against wear and tear by means of high-speed flame spraying. The alloy components used in both publications form a nickel-chromium matrix, in which depending on the alloying contribution chromium-carbides are embedded. The drawback to these coatings is that, due to their hardness and brittleness they are subject to cracks, whereby the susceptibility to cracking can even be the determining factor for the service life of the piston rings. This susceptibility to cracking results from the great carbide diameters, which, when conditioned by stress leads to carbide fractures and thus to wear and tear on the rings. In particular in the plasma powders the carbides are present in an already decomposed form, so that the matrix embrittles and the carbide loses hardness through transformation of Cr3C2 to Cr7C3 or even to Cr23C6. To oppose this drawback, in DE 197 20 627 A1 20 to 80 Vol-% of molybdenum is mixed into the spray powder. Molybdenum possesses a relatively high viscosity and can thus stop the crack growth. The patent application discloses preferred coatings of sintered chromium-carbide and nickel chromium powders with up to 100% weight molybdenum. By means of introducing the molybdenum into the powder, however, in the resulting coating phases made of molybdenum come into being, which are roughly the size of the initial powder and as a rule have a diameter of 5 to 50 μm. The relatively low resistance to abrasion of the molybdenum has a negative effect, the molybdenum phases are preferably worn out and consequently reduce the protective layer's resistance to wear and tear.

Along with the chromium carbides, tungsten carbides are also embedded into the matrix of the protective layer against wear and tear. The European patent publication EP 0 512 805 B1 describes the formation of a surface protection with chromium and tungsten carbides, whereby the embedded tungsten-chromium-carbides have a particle size in the range of 25-100 μm. Tungsten carbides are harder than chromium carbides and possess a very high resistance to wear and tear and pressure. The extraordinarily hard tungsten carbides, however, show a significant disadvantage in the processing of the produced surface. The surface can no longer be finished with conventional grinding wheels, processing is only possible with very high-quality and at the same time expensive grinding wheels.

The invention is based on the object of overcoming the disadvantages that are part of the state of the art and producing a protective layer against wear and tear that is nearly crack-free and possesses a high resistance to wear and tear.

This object is solved in accordance with the invention by means of the characterizing part of claim 1, advantageous improvements of the invention are documented in the subordinate claims.

The invention's protective layer against wear and tear for the contact surface of the piston ring is formed of a powder mixture in which the first powder exists as agglomerated and sintered powder made out of the alloy components chromium carbide, chromium and nickel, which has not experienced any subsequent embrittling heat treatment such as e.g. a plasma age hardening, whereby the carbides in the powder have a mean diameter that is essentially not greater than 3 μm and a second powder that is also present as an agglomerated and sintered powder and contains tungsten carbide as an essential characteristic and is applied to at least one peripheral area of the piston rings by means of thermal spraying, so that two differing layer areas are produced in the protective layer against wear and tear, whereby a first area develops that is primarily rich in chromium carbide and a second area develops that is chiefly rich in tungsten carbide.

The use of a powder with a carbide size of less than 3 μm is a significant difference to the conventionally used powders, whose mean carbide size is over 5 μm, mostly however even above 10 μm. By reducing the carbide size, the carbide outbreak is lowered, the risk of cracking is minimized and at the same time the internal stresses in the carbide are reduced, which in turn lowers the carbide shattering tendency. A further significant difference is the use of primary carbides in the initial powder, which are predominantly present as Cr3C2 and Cr7C3 carbides. The powder gained by means of the conventional fusion spraying on the other hand have mostly dendritic carbides and predominantly dissolved carbides such as for example Cr23C6, which are very much softer.

In accordance with the invention two different layer areas develop as the basis in the protective layer against wear and tear. The layer structure is disordered. For example a matrix out of nickel, chromium and molybdenum forms the first layer area, into which homogenous and finely distributed chromium carbides and molybdenum phases are embedded. In contrast to the 5 to 50 m large molybdenum phases known from the state of the art, the molybdenum phases are only present in a size of below 5 m, so that there are no wear and tear increasing phases present in the matrix.

In the second visibly differing layer area predominately tungsten and chromium carbides are embedded in the nickel matrix. The tungsten carbides have a diameter that is basically less than 1.5 μm and the chromium carbides have a diameter that is basically less than 3 μm, by means of which the metal cutting is supported. A ratio corresponding to this layer structure could for example consist of 2 parts areas rich in tungsten carbide and 8 parts areas rich in chromium carbide. Experiments in real internal combustion engines have shown that a protective layer against wear and tear on piston rings developed in accordance with this example has a complete freedom from cracks and a wear and tear behavior that is nearly comparable with galvanically produced layers.

By means of the superimposition of the two layer materials in a protective layer against wear and tear it is now possible to combine the relatively good machinability of the chromium carbides with the very high resistance to wear and tear of the tungsten carbides. One advantage resulting from this is the fact that machining at full freedom from cracks is possible without problems with conventional grinding wheels, that is, finishing is not more cost-intensive than with a conventional protective layer against wear and tear created by today's plasma spraying techniques.

The cobalt components in the alloy serve in particular as a binding agent in the areas that are rich in tungsten carbide. The hard material phases chromium carbide and tungsten carbide are the carriers of the hardness and determine among other things the wearing properties, while the auxiliary metal gives the protective layer against wear and tear its toughness.

A protective layer against wear and tear for a piston ring of an internal combustion machine in accordance with the invention is represented in the drawing using an embodiment and will be described in greater detail in the following. The figures show the following:

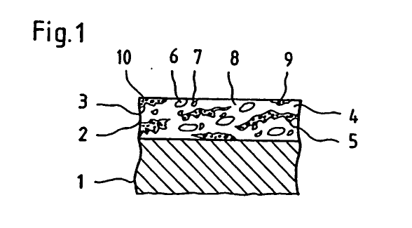

FIG. 1 shows a longitudinal cross section through a protective layer against wear and tear on a piston ring. In FIG. 1 a protective layer against wear and tear 2 is applied to a piston ring 1. The bounds 3 in the protective layer against wear and tear 2 mark the different layer areas 4 and 5. Layer area 4 contains primarily chromium carbide rich phases 6 and molybdenum phases 7, the matrix 8 consists chiefly of nickel and chromium. Layer area 5 in this embodiment also has a nickel chromium matrix, in which mainly tungsten carbides 9 and chromium carbides 10 are embedded.

1. Protective layer for piston rings in internal combustion machines, essentially consisting of chromium carbides, tungsten carbide, chromium and nickel, characterized by the fact that the protective layer against wear and tear is formed of a powder mixture in which the first powder exists as agglomerated and sintered powder made out of at least the alloy components chromium carbide, chromium and nickel, which has not experienced any subsequent embrittling heat treatment such as e.g. a plasma age hardening, whereby the carbides in the powder have a mean diameter that is essentially not greater than 3 μm and a second powder that is also present as an agglomerated and sintered powder and contains tungsten carbide as an essential characteristic and is applied to at least one area of the piston rings by means of thermal spraying, so that two differing layer areas are produced in the protective layer against wear and tear, whereby a first area develops that is primarily rich in chromium carbide and a second area develops that is chiefly rich in tungsten carbide.

2. Protective layer against wear and tear according to claim 1, characterized by the fact that the second powder additionally contains chromium, carbon and nickel, so that during spraying areas rich in tungsten carbide result, in which primarily tungsten carbides, chromium carbides and nickel are present.

3. Protective layer against wear and tear according to one of claims 1 and 2, characterized by the fact that the alloy components in the areas that are rich in tungsten carbides are present with percentages of carbon between 8 and 11%, between 6 and 8% in nickel, between 18 and 24% in chromium and the rest in tungsten.

4. Protective layer against wear and tear according to claim 1, characterized by the fact that the second powder additionally contains nickel, so that during spraying areas rich in tungsten carbide result, in which primarily tungsten carbides and nickel are present.

5. Protective layer against wear and tear according to one of claims 1 and 4, characterized by the fact that the alloy components are present with percentages of carbon between 4 and 6%, between 11 and 18% in nickel, and the rest in tungsten.

6. Protective layer against wear and tear according to claim 1, characterized by the fact that the second powder additionally contains cobalt and chromium, so that during spraying areas rich in tungsten carbide result, in which primarily tungsten carbides are present in a cobalt chromium alloy.

7. Protective layer against wear and tear according to one of claims 1 and 6, characterized by the fact that the alloy components are present with percentages of cobalt between 6 and 18%, between 0.1 and 9% in chromium, and the rest in tungsten.

8. Protective layer against wear and tear according to one of claims 1 through 7, characterized by the fact that the areas rich in chromium carbide additionally contain molybdenum.

9. Protective layer against wear and tear according to one of claims 1 through 8, characterized by the fact that the areas rich in chromium carbide contain between 7 and 10% carbon, 10-20% nickel, 1-10% molybdenum and the rest in chromium.

10. Protective layer against wear and tear according to one of claims 1 through 9, characterized by the fact that the percentage of the areas rich in tungsten carbide in the mixture amounts to between 1 and 95 Vol. %.

11. Protective layer against wear and tear according to one of claims 1 through 10, characterized by the fact that the diameter of the phases rich in molybdenum in the areas rich in chromium are basically not greater than 5 μm.

12. Protective layer against wear and tear according to one of claims 1 through 11, characterized by the fact that the tungsten carbides in the agent are not greater than 1.5 μm.

13. Protective layer against wear and tear according to one of claims 1 through 12, characterized by the fact that the tungsten carbides are present as WC carbides and as modifications of the tungsten carbide.

14. Protective layer against wear and tear according to one of claims 1 through 13, characterized by the fact that the chromium carbides essentially do not exceed a mean diameter of 8 μm.

15. Protective layer against wear and tear according to one of claims 1 through 14, characterized by the fact that the chromium carbides are present as Cr3C2 carbides and as modifications of the chromium carbide.

16. Protective layer against wear and tear according to one of claims 1 through 15, characterized by the fact that the high speed flame spraying method (HVOF) is used as thermal spraying technique.
